(19) United States
(12) Patent Application Publication
(10) Pub. No.: US 2006/0260913 A1
(43) Pub. Date: Nov. 23, 2006

(54) RETRACTABLE MULTIPLE-STAGE TRAILER LOADER/UNLOADER APPARATUS

(76) Inventors: Stephen C. Wolf, Grand Rapids, MI (US); Daniel P. Modzeleski, Grand Rapids, MI (US); Dennis J. Schuitema, Ada, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/419,109

(22) Filed: May 18, 2006

Related U.S. Application Data
(60) Provisional application No. 60/682,887, filed on May 20, 2005.

(51) Int. Cl. B65G 21/14; B65G 17/24

(52) U.S. Cl. 198/812; 198/779

(57) ABSTRACT

An extendable multi-stage trailer loader or unloader apparatus includes a frame assembly having first and second frame members that are interconnected. The second frame member is selectively extendable from the first frame member. A first conveying surface is supported by the first frame member and defines a first conveyor. The first conveying surface is operable to convey articles between an upstream end of the first conveyor and a downstream end of the first conveyor. A second conveying surface is supported by the second conveying member. The second conveying surface is defined by a second conveyor. The second conveying surface is operable for conveying articles between the downstream end of the first conveyor and a downstream end of the second conveyor. The second conveyor includes a flexible support supporting the second conveying surface.

### CROSS REFERENCE TO RELATED APPLICATION

This application claims priority from U.S. provisional patent application Ser. No. 60/682,887, filed on May 20, 2005, the disclosure of which is hereby incorporated herein by reference in its entirety.

### BACKGROUND OF THE INVENTION

The present invention relates to conveyors and in particular to a multiple stage arrangement for loading and/or unloading trailers, and the like, from a dock area.

Large trailers and other similar cargo carrying vehicles are typically loaded and unloaded from an elevated dock area of a warehouse or factory where space is often limited. The bays in loading docks are rather narrow and spaced closely together in a side-by-side fashion. Conventional telescoping or extending conveyors may be used to transport packages from a loading dock into a trailer or truck bed. Such a trailer loader is disclosed in the commonly assigned U.S. Pat. No. 4,425,069 filed Jun. 12, 1981, by Saur et al., and entitled TRANSPORT FOR LOADING SEMITRAILERS AND THE LIKE, the disclosure of which is hereby incorporated herein by reference. Such conveyors are at a grade to transport packages by the force of gravity. It is known to provide such conveyors having two-part conveyor arrangements with angled transition sections in between each part of the conveyor. In certain situations, the grade of the conveyor causes packages to accelerate at high and uncontrollable speeds, which may result in jams. Additionally, the angled transition section may cause packages to gain speed and/or jump, loss of control of packages, resulting in potential jams on the conveyor, and packages toppling over or off the conveyor causing damage.

Thus, there is a need and desire for a conveyor system for loading trailers, and the like, which moderates the flow, speed and orientation of packages conveyed on such telescoping conveyors to prevent jams and damage to packages.

### SUMMARY OF THE INVENTION

Accordingly, the present invention provides an expandable multiple-stage trailer loader which overcomes a number of the above-discussed difficulties.

An extendable multi-stage trailer loader or unloader apparatus according to an aspect of the invention includes a frame assembly having first and second frame members that are interconnected. The second frame member is selectively extendable from the first frame member. A first conveying surface is supported by the first frame member and defines a first conveyor. The first conveying surface is operable to convey articles between an upstream end of the first conveyor and a downstream end of the first conveyor. A second conveying surface is supported by the second conveying member. The second conveying surface is defined by a second conveyor. The second conveying surface is operable for conveying articles between the downstream end of the first conveyor and a downstream end of the second conveyor. The second conveyor includes a flexible support supporting the second conveying surface.

An extendable multi-stage trailer loader or unloader apparatus according to another aspect of the invention includes a frame assembly made up of first and second frame members that are interconnected. The second frame member is selectively extendable from the first frame member. A first conveyor is supported by the first frame member. The first conveyor is made up of a conveyor belt and a drive motor for driving the conveyor belt. The conveyor belt defines a first conveying surface operable for conveying articles from an upstream end to a downstream end of the first conveyor. A second conveyor is supported by the second frame member. The second conveyor is made up of a second conveying surface extending from the first frame member. The second conveying surface is operable for conveying articles from the downstream end of the first conveying surface to a downstream end of a second conveying surface. The second conveying surface is made up of a plurality of freely rotating conveying members and a flexible support. The flexible support supports the freely rotating conveying members from a portion of an upward facing surface of the second frame member that is extending beyond the first frame member.

An extendable multi-stage trailer loader or unloader apparatus according to yet another aspect of the invention includes a frame assembly made up of first and second frame members that are interconnected. The second frame member is selectively extendable from the first frame member. The first conveying surface is supported by the first frame member. The first conveying surface is defined by a first conveyor. The first conveying surface is operable to convey articles between an upstream end of the first conveyor and a downstream end of the first conveyor. A flexible second conveyor is supported by the second frame member. The flexible second conveyor defines a second conveying surface. The second conveying surface is operable for conveying articles between the downstream end of the first conveyor and a downstream end of the second conveyor. The flexible second conveyor is attached at opposite ends to the first frame member and extends around the second frame member. The flexible second conveyor has a first portion supported at an upper portion of said second frame member and a second portion supported at a lower portion of said second frame member. Relative lengths of the first and second portions are different for different relative positions of the first and second frame members.

These and other objects, advantages and features of this invention will become apparent upon review of the following specification in conjunction with the drawings.

### BRIEF DESCRIPTION OF THE DRAWINGS

FIG. 1 is a side elevation of an extendable multiple-stage transportable trailer loader or unloader apparatus according to the present invention in a partially extended position;

FIG. 2 is the same view as FIG. 1 in a retracted position;

FIG. 3 is a front elevation taken in the direction III-III in FIG. 2;

FIG. 4 is an enlarged view of the area IV in FIG. 1;

FIG. 5 is a top plan view taken in the direction V-V in FIG. 4;

FIG. 6 is the same view as FIG. 4 of an alternative embodiment of the present invention;

FIG. 7 is the same view as FIG. 5 of the embodiment illustrated in FIG. 6; and

FIG. 8 is the same view as FIG. 4 of another alternative embodiment of the present invention;

FIG. 9 is the same view as FIG. 5 of the embodiment illustrated in FIG. 8;

FIGS. 10a and 10b are side elevational views of yet another alternative embodiment of the present invention.

### DETAILED DESCRIPTION OF THE PREFERRED EMBODIMENTS

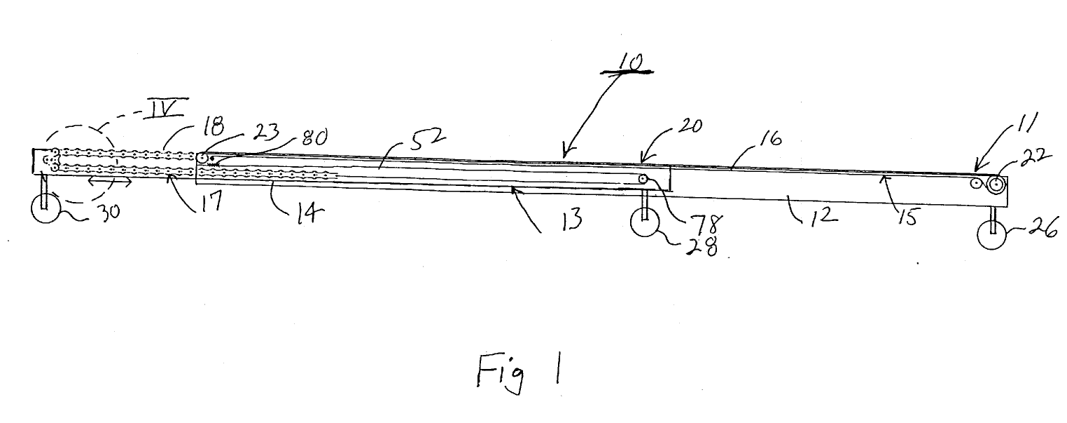

Referring now to the drawings and the illustrative embodiments depicted therein, an extendable multiple-stage trailer loader apparatus 10 includes a first section 11 having a first frame member 12 and a first conveyor 15 having a first conveying surface 16. Apparatus 10 further includes a second section 13 having a second frame member 14 and a second conveyor 17 having a second conveying surface 18. Conveying surfaces 16, 18 define a main conveying surface 20 (FIG. 1). Second frame member 14 retracts to and extends from first frame member 12 to adjust the overall length of main conveying surface 20 of trailer loader 10.

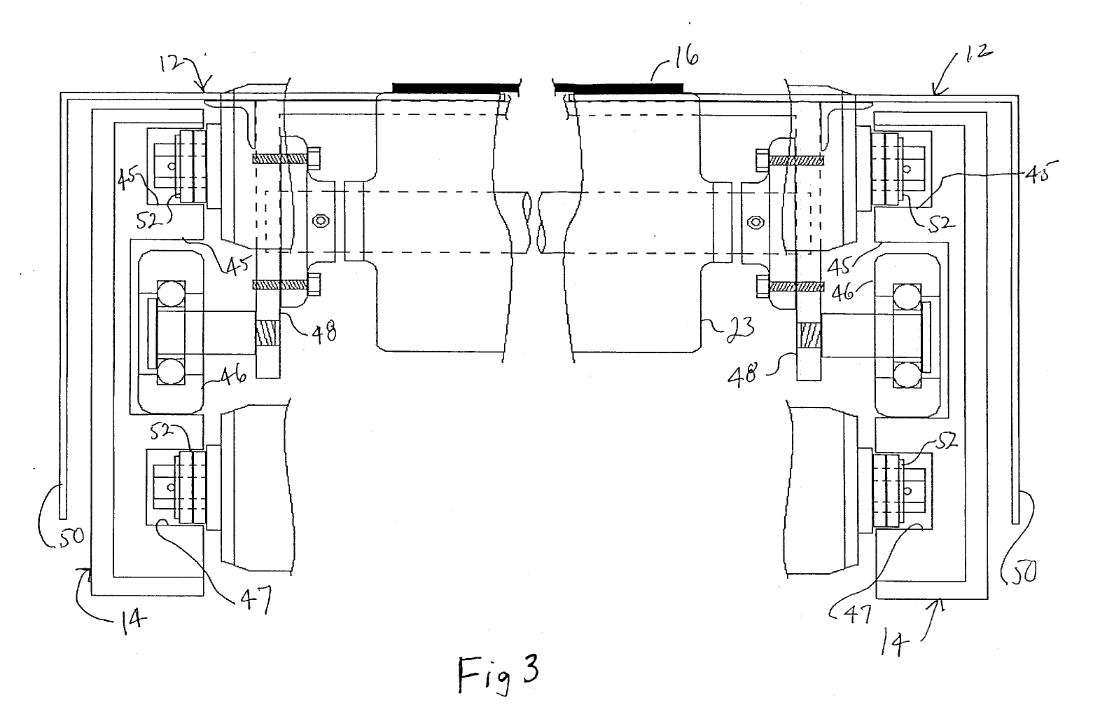

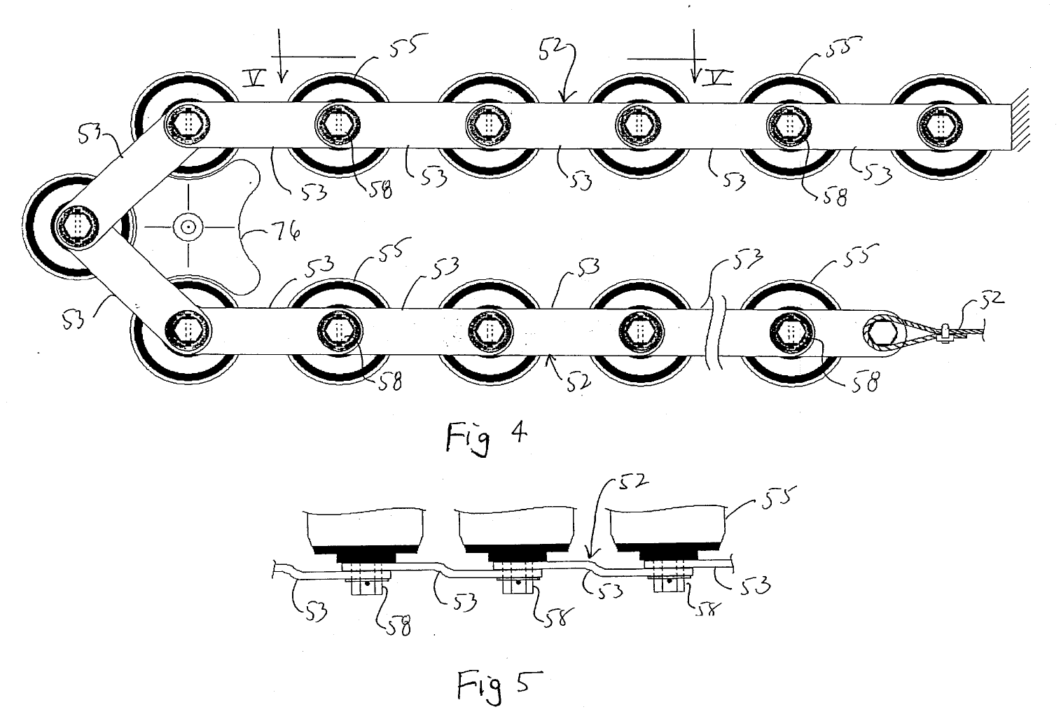

As best illustrated in FIG. 3, downward facing surfaces 45 of second frame member 14 engages a series of guide wheels 46 mounted on first frame member 12 at the bottom of the side members 48 of the first frame member. Guide wheels 46 allow second frame member 14 to retract to and extend from first frame member 12. Alternatively, in keeping within the spirit of the invention, guide wheels 46 may be attached to second frame member 14 and roll along the side channel of first frame member 12. Moreover, other sliding or rolling mechanisms are contemplated by the present invention, such as roller balls, sliding roller cantilevers, and the like. Side plates 50 may be provided that extend outwardly of the side members to provide additional stiffness to first frame member 12 as well as to generally cover second frame member 14.

Apparatus 10 further provides a substantially planar main conveying surface 20 formed by first conveying surface 16 generally supported by first frame member 12 and second conveying surface 18 generally supported by second frame member 14. The overall length of main conveying surface 20 is adjustable. The length of first conveying surface 16 is fixed. The length of second conveying surface 18 is determined by the position of second frame member 14 with respect to first frame member 12 providing a plurality of different lengths for the second conveying surface. Regardless of the relative retraction or extension of frame members 14, 16, the tension on second conveying surface 18 remains generally constant to maintain a planar main conveying surface 20 as the second conveying surface wraps underneath the second frame member, which is discussed in greater detail below.

In the illustrated embodiments, first conveying surface 16 is a belt conveyor reaved about a motor driven pulley 22 and idler pulley 23. First conveying surface 16 transports articles or packages toward second conveying surface 18. The motor for driven pulley 22 can be mounted under first conveying surface 16 and up between side members 48 of first frame member 12. Alternatively, first conveying surface 16 may be a gravity roller conveyor, a powered roller conveyor, a gravity wheel conveyor, or any like gravity conveyor. In yet another embodiment, first conveying surface 16 may be divided into a plurality of zones or beds with a plurality of motorized rollers 22 and article sensors (not shown), with one motorized roller and article sensor per zone, to accommodate greater conveyor lengths and provide greater control of packages conveyed such as by facilitating accumulation of articles in the zones, as is known in the art. First conveying surface 16 may be driven at a constant or an adjustable speed by motor 22 to feed packages onto second conveying surface 18.

Second frame member 14 supports second conveyor 17 which is illustrated as a flexible web and may include a pair of flexible supports 52, such as laterally spaced apart chains. Each flexible support 52 is received and supported by an upper upward facing surface 45 and a lower upward facing surface 47 of second frame member 14. Each flexible support 52 in the illustrated embodiments is a chain made up of a series of links 53, each interconnecting adjacent axles 58 of rollers 55. Each flexible support 52 is generally restrained in its axes of elongation, meaning that it will not significantly elongate when pulled from opposite ends. However, each flexible support 52 is flexible perpendicular to its axis of elongation, thus allowing the flexible support 52 to wrap to, for example, 180 degrees as seen in FIG. 4. Flexible support 52 may be other flexible elongated members including, but not limited to, cables, articulated plates, plastic mesh, and the like. Second conveyor 17 further includes a second conveying surface 18 received between and laterally supported by flexible supports 52. Conveying surface 18 may be defined by a plurality of evenly spaced elongated members 55, such as gravity rollers supported by flexible supports 52. Rollers 55 are rotatably mounted by axles 58 which are supported at opposite ends by respective flexible support 52. In this manner, rollers 55 form a gravity roller conveying surface 18 that transports packages under the force of gravity, so long as second conveying surface 18 is pitched. Alternatively, conveying surface 54 may accommodate a plurality of free-rotating conveying members, such as roller wheels, roller balls, or the like. If it is desired to provide a trailer unloader, rollers 55 may be powered rollers, or may be rotated by a powered belt, both of which are known in the art, or the like.

In another embodiment of the invention, second conveying surface 18 may be defined by a flexible web (not shown) between a pair of laterally spaced flexible supports 52 with a plurality of freely rotating conveying members joined to the flexible web. The flexible web may be in the form of a flexible weave or cross pattern, while keeping within the spirit of the invention, so long as the material provides a planar conveying surface which is capable of providing a surface to transport packages with either gravity or by rollers. Alternatively, flexible conveying surface 18 may be made of a material with a low coefficient of function which allows packages to slide down at a slower rate of speed under the pace of gravity.

In yet another embodiment, flexible conveying surface 18 may provide a series of evenly spaced rotating members, such as wheels, mounted to axles that are supported at opposite ends by respective flexible support 52. Other members, which may be rods, tubes, slates, or the like, may be provided to receive and accommodate freely rotatable conveying members to form conveying surface 54.

In the illustrated embodiment, flexible supports 52 of second conveyor 17 connect to first frame member 12 and are horizontally supported by upward facing surfaces 45, 47 of second frame member 14. Second conveyor 17 extends around the distal end of second frame member 14 over a toothed sheave 76 and wraps underneath or below the second frame member where it is supported by lower upward facing surfaces 47. The other end of flexible supports 52 attaches to a pair of cables 24. Cables 24 wrap around the upstream end of second frame member 14, such as by a sheave 78. Cables 24 terminate to the downstream end of first frame member 12 by way of a tensioning member, such as a spring 80, which assists in maintaining a constant tension on second conveyor 17.

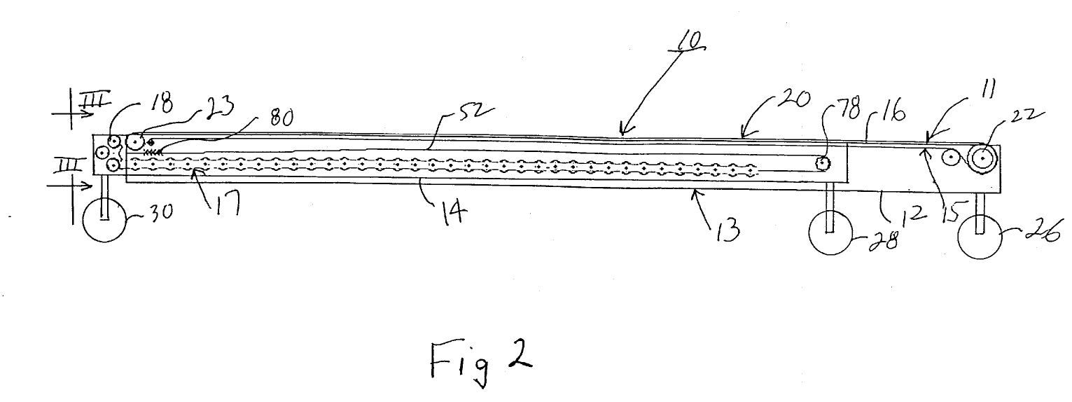

In the illustrative embodiments, the sum length of flexible supports 52 and cable 24 of second conveyor 17 are fixed. As second frame member 14 moves relative to first frame member 12, second conveyor 17 is exchanged between upper and lower support surfaces 45, 47, while cable 24 maintains the tension as the second conveyor moves about toothed sheave 76. For example, as second frame member 14 extends from first frame member 12, a greater portion of second conveying conveyor 17 moves to the top of the second frame member and less on the bottom as seen in FIG. 1. As second frame member 14 retracts with respect to first frame member 12, a greater portion of second conveyor 17 is displaced and moved to the bottom of the second frame member and less on top as seen in FIG. 2. Flexible members 52 do not move relative to first frame member 12 as the second frame member slides along flexible members 52 during the retraction and extension of second conveying surface 18.

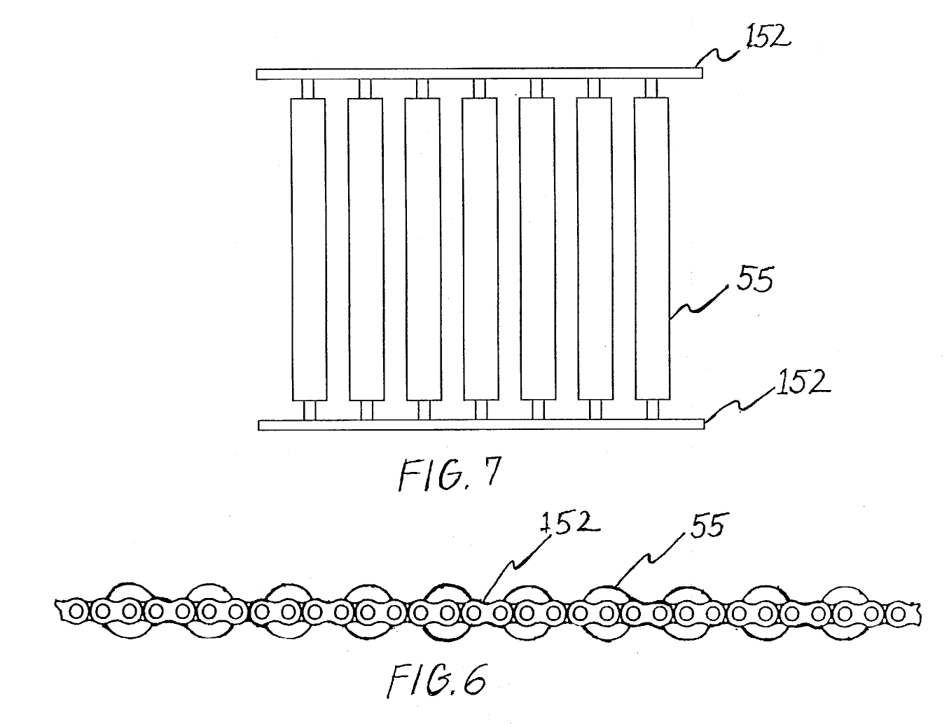

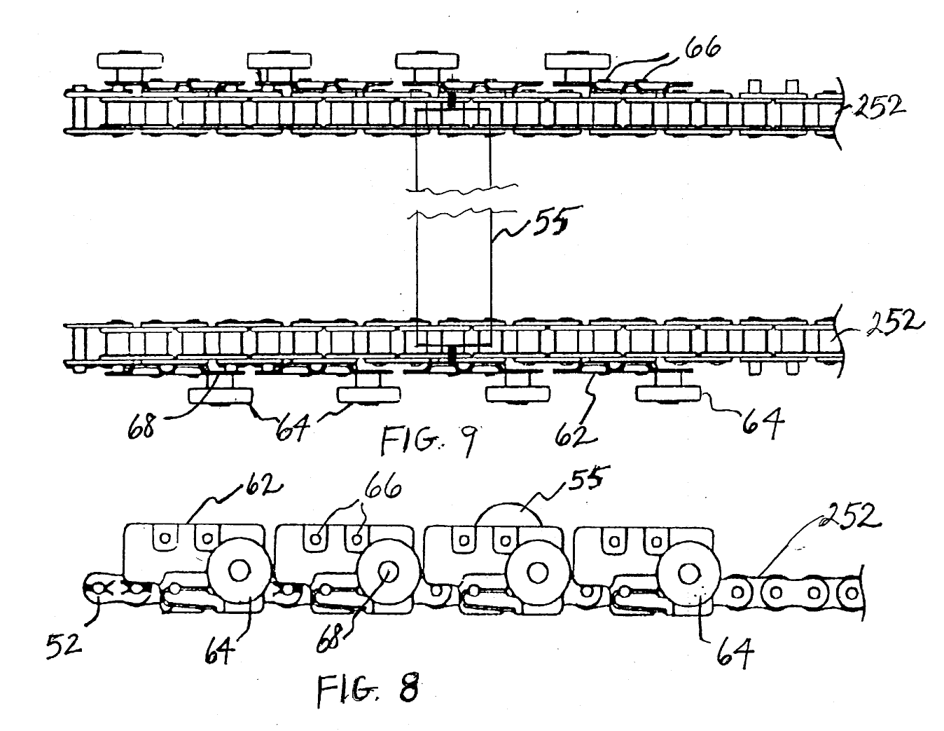

In another embodiment of the present invention, flexible support 152 may be a conventional chain having two or more links between each roller 55 (FIGS. 6 and 7). In yet another embodiment, flexible support 252 may include an end plate 62 to support and receive a chain wheel 64 and elements of flexible conveying surface 54 (FIGS. 8 and 9). End plate 62 may be received and mounted to the side of chain 252, and received by at least two links of the chain. In this illustrated embodiment, end plate 62 is received on chain 252 on the side away from flexible conveying surface 54. End plate 62 includes flexible conveyor surface member holes 66 and chain wheel holes 68. Chain wheels 64 are supported by surfaces 45, 47 of second frame member 14. Flexible conveying surface member holes 66 receive an extended axle of gravity rollers 58, which are then bolted or attached in some other manner, such as by a cotter pin, or the like.

Trailer loader/unloader apparatus 10 may include a rear set of wheels 26 attached to first frame member 12. Trailer loader 10 further includes a middle set of wheels 28 and a front set of wheels 30 attached to second frame member 14. Wheel sets 26, 28, and 30 are preferably in pairs. Wheel sets 26, 28, 30 support, maneuver and position trailer loader/unloader apparatus 10 into a trailer to load or unload packages. One or more of wheel sets 28 and 30 may be motorized and also may have the capability to steer for controlling the position of trailer loader 10. When second section 13 reaches full extension, the driven wheels then pull first section 11 forward in unison with the second section, as illustrated in U.S. Pat. No. 7,004,308 B2, the disclosure of which is hereby incorporated herein by reference.

Alternatively, as second frame member 14 retracts into first frame member 12, when second frame member 14 reaches full retraction, it drives first section 11 backwards or to the right as viewed in FIGS. 1 and 2. Therefore, second frame member 14 must either be fully extended or fully retracted with respect to first frame member 12 before it moves first section 11 forward or backward.

Movement and maneuvering of trailer loader 10 can be controlled through a control panel (not shown), which may be located on the forward end of trailer loader/unloader apparatus 10 or remotely with a wireless communication means, such as radio frequency, or the like.

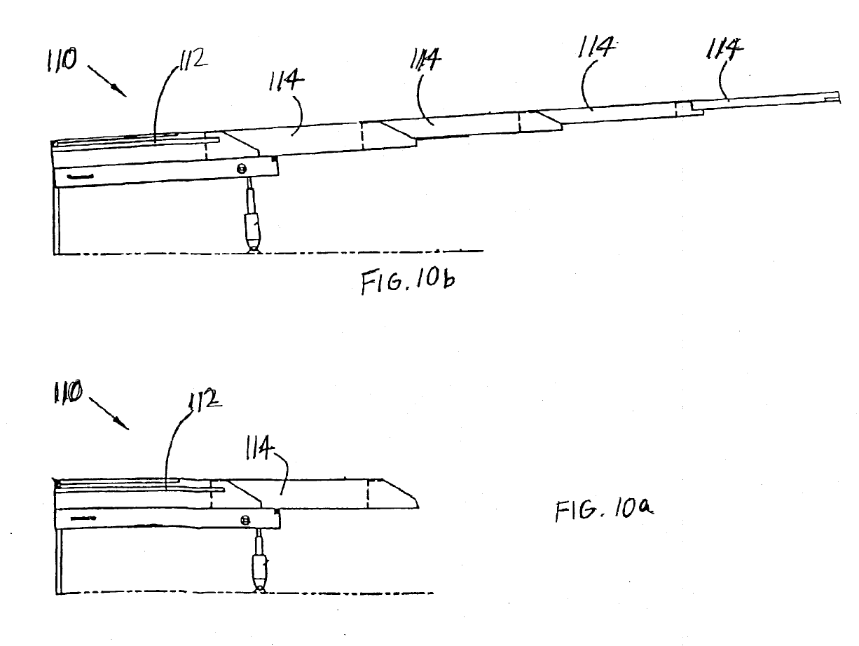

Alternatively, a trailer loader 110 may be provided that includes cantilever supported members. For example, second frame member 114 may be cantilevered to and supported by first frame member 112, as best illustrated in FIG. 10a. Cantilevered trailer loaders and unloaders are known in the art and are disclosed by way of example in U.S. Pat. No. 6,006,893, filed Feb. 13, 1997, by Gilmore et al., and entitled EXTENDABLE TRAILER LOADER/UNLOADER WITH USER INTERFACE SECTION; U.S. Pat. No. 6,481,563 filed Dec. 29, 1999, by Gilmore, and entitled EXTENDABLE CONVEYOR WITH ADDITIONAL BOOM SECTION; and U.S. Pat. No. 6,571,938 filed Oct. 10, 2002, by Gilmore, and entitled EXTENDABLE CONVEYOR WITH ADDITIONAL BOOM SECTION, the disclosures of which are incorporated herein by reference. The plurality of cantilevered sections 114 of trailer loader 110 are illustrated in FIG. 10b in an extended position, extending from first frame member 112.

Having described the invention in connection with certain specific embodiments thereof, it is to be understood that the description is meant to be interpreted as illustrative only, and that various modifications may also be made by those skilled in the art without departing from the spirit and scope of the invention as expressed in the accompanying claims.

The embodiments of the invention in which an exclusive property or privilege is claimed are defined as follows:

1. An extendable multiple-stage trailer loader or unloader apparatus, said apparatus comprising:
a frame assembly comprising first and second frame members that are interconnected wherein said second frame member is selectively extendable from said first frame member;
a first conveying surface supported by said first frame member, said first conveying surface defined by a first conveyor, said first conveying surface operable to convey articles between an upstream end of said first conveyor and a downstream end of said first conveyor; and
a second conveying surface supported by said second frame member, said second conveying surface defined by a second conveyor, said second conveying surface operable for conveying articles between the downstream end of said first conveyor and a downstream end of said second conveyor;
wherein said second conveyor including a flexible support supporting said second conveying surface.

2. The apparatus of claim 1 wherein said second conveying surface comprises a gravity conveying surface.

3. The apparatus of claim 1 wherein said second conveyor extends from said first frame member.

4. The apparatus of claim 3 wherein said flexible support is attached at one end to said first frame member and extends around the downstream end of said second frame member.

5. The apparatus of claim 4 wherein said flexible support is attached at an opposite end to said first frame member and extends around the upstream end of said second frame member.

6. The apparatus of claim 5 including a first sheave at said downstream end of said second frame member and a second sheave at said upstream end of said second frame member, said flexible support extending around said first and second sheaves.

7. The apparatus of claim 6 wherein said flexible support comprises a first portion supporting said second conveying surface and a second portion, said second portion comprising a cable.

8. The apparatus of claim 7 wherein said cable extends around said second sheave and is attached to said first frame member.

9. The apparatus of claim 8 wherein said cable attaches to said first frame member with a tensioning member.

10. The apparatus of claim 1 wherein said flexible support comprises a pair of chains.

11. The apparatus of claim 10 wherein said chains are supported by upward facing surface portion of said second frame member.

12. The apparatus of claim 10 wherein said second conveying surface is defined by a plurality of spaced elongated members, wherein ends of said elongated members are supported by said chains.

13. The apparatus of claim 12 wherein said elongated members comprise gravity rollers.

14. The apparatus of claim 13 wherein said ends of said elongated members comprise axles fastened to said chains.

15. The apparatus of claim 14 wherein each of said chains comprises links interconnecting adjacent ones of said axles.

16. The apparatus of claim 1 further including a set of wheels supporting said first and second frame assemblies, said set of wheels operable for positioning said apparatus and for extending and retracting said second frame member relative to said first frame member for adjusting a length of said first and second conveying surfaces.

17. The apparatus of claim 16 wherein said set of wheels include motorized drive wheels.

18. The apparatus of claim 1 wherein said flexible support is elongated along an axis of elongation, wherein said flexible support is restrained in said axis of elongation and not restrained perpendicular to said axis of elongation.

19. The apparatus of claim 1 wherein said first conveyor comprises a conveyor belt and a motor driving said conveyor belt.

20. An extendable multiple-stage trailer loader or unloader apparatus, said apparatus comprising:
a frame assembly comprising first and second frame members that are interconnected, wherein said second frame member is selectively extendable from said first frame member;
a first conveyor supported by said first frame member, said first conveyor comprising a conveyor belt and a drive motor for driving said conveyor belt, wherein said conveyor belt defining a first conveying surface operable for conveying articles from an upstream end to a downstream end of said first conveyor; and
a second conveyor supported by said second frame member, said second conveyor comprising a second conveying surface extending from said first frame member, said second conveying surface operable for conveying articles from the downstream end of said first conveying surface to a downstream end of said second conveying surface, said second conveying surface made up of a plurality of free-rotating conveying members and a flexible support, said flexible support supporting said free-rotating conveying members from a portion of an upward facing surface of said second frame member that is extended beyond said first frame member.

21. The apparatus of claim 20 wherein said plurality of free-rotating conveying members comprises a plurality of gravity rollers.

22. The apparatus of claim 20 wherein said second conveying surface attaches to said first frame member, said first conveying surface and said second conveying surface being substantially co-planar.

23. The apparatus of claim 20 wherein said flexible support is attached at one end to said first frame member and extends around the downstream end of said second frame member.

24. The apparatus of claim 23 wherein said flexible support is attached at an opposite end to said first frame member and extends around the upstream end of said second frame member.

25. The apparatus of claim 24 including a first sheave at said downstream end of said second frame member and a second sheave at said upstream end of said second frame member, said flexible support extending around said first and second sheaves.

26. The apparatus of claim 25 wherein said flexible support comprises a first portion supporting said second conveying surface and a second portion, said second portion comprising a cable.

27. The apparatus of claim 26 wherein said cable extends around said second sheave and is attached to said first frame member.

28. The apparatus of claim 27 wherein said cable attaches to said first frame member with a tensioning member.

29. The apparatus of claim 20 wherein said flexible support comprises a pair of chains.

30. The apparatus of claim 29 wherein said second conveying surface is defined by a plurality of spaced elongated members, wherein ends of said elongated members are supported by said chains.

31. The apparatus of claim 30 wherein said ends of said conveying members comprise axles fastened to said chains.

32. The apparatus of claim 31 wherein each of said chains comprises links interconnecting adjacent ones of said axles.

33. The apparatus of claim 20 further including a set of wheels supporting said first and second frame assemblies, said set of wheels operable for positioning said apparatus and for extending and retracting said second frame member relative to said first frame member for adjusting a length of said first and second conveying surfaces.

34. The apparatus of claim 33 wherein said set of wheels include motorized drive wheels.

35. The apparatus of claim 20 wherein said flexible support is elongated along an axis of elongation, wherein said flexible support is restrained in said axis of elongation and not restrained perpendicular to said axis of elongation.

36. An extendable multiple-stage trailer loader or unloader apparatus, said apparatus comprising:
a frame assembly comprising first and second frame members that are interconnected wherein said second frame member is selectively extendable from said first frame member;
a first conveying surface supported by said first frame member, said first conveying surface defined by a first conveyor, said first conveying surface operable to convey articles between an upstream end of said first conveyor and a downstream end of said first conveyor; and
a flexible second conveyor supported by said second frame member, said flexible second conveyor defining a second conveying surface, said second conveying surface operable for conveying articles between the downstream end of said first conveyor and a downstream end of said second conveyor;
wherein said flexible second conveyor is attached at opposite ends to said first frame member and extends around said second frame member, wherein said flexible second conveyor has a first portion supported at an upper portion of said second frame member and a second portion supported at a lower portion of said second frame member, wherein relative lengths of said first and second portions being different for different relative positions of said first and second frame members.

37. The apparatus of claim 36 wherein said flexible second conveyor comprises said second conveying surface and a cable extending from said second conveying surface.
